(19) United States
(12) Patent Application Publication
(10) Pub. No.: US 2003/0017868 A1
(43) Pub. Date: Jan. 23, 2003

(54) System and method for multi-line slot machines

(76) Inventor: Curtis Crawford, Henderson, NV (US)

Correspondence Address: Intellectual Property Department, DORSEY & WHITNEY LLP, Suite 400 South, 1001 Pennsylvania Avenue, N.W., Washington, DC, 20004-2533, US

(21) Appl. No.: 10/198,600

(22) Filed: Jul. 19, 2002

Related U.S. Application Data
(60) Provisional application No. 60/306,147, filed on Jul. 19, 2001.

(51) Int. Cl. A63F 13/00

(52) U.S. Cl. 463/20

(57) ABSTRACT

A slot machine device, method and system provides the user of the slot machine with increased opportunities to purchase wagers on multiple paylines. The increased number of paylines is derived from utilizing a 5×5 matrix of rows and columns and applying innovative payline patterns to the matrix. The innovative payline patterns include row, column, diagonal, semi-diagonal, and displaced line paylines.

### CROSS REFERENCE TO PRIORITY APPLICATION

The present application claims priority on a provisional application, U.S. Serial No. 60/306,147, entitled “System and Method for Multi-Line Slot Machines”, filed on Jul. 19, 2001, which is incorporated by reference herein.

### BACKGROUND OF THE INVENTION

1. Field of the Invention

The present invention is directed to improvements in gaming devices. In particular, the invention relates to an improved method and system for selecting winning paylines in multi-line slot machines.

2. Background and Objects of the Invention

Previous art related to multi-line slot machines involves various methods to recognize winner paylines in various gaming devices, including reel slot-machines, video slot machines and video poker. The references, however, do not disclose methods for calculating winner paylines based on a user's choice of one or more of row, column, diagonal, semi-diagonal and displaced-line payline calculations in a slot machine matrix composed of 5 rows by 5 columns.

Exemplary samples of the known prior art include: U.S. Pat. No. 6,093,102, entitled “Multiline Gaming Machine,” by Bennet, which describes a method for calculating winner paylines on a slot machine based upon recognizing a single element of each column in an array with 3 rows; U.S. Pat. No. 5,580,053, entitled “Multi-Line Gaming Machine,” by Crouch, which also describes a method for calculating winner paylines based upon recognizing a single element of each column in an array of 3 rows and 5 columns; U.S. Pat. No. Re. 34,244, entitled “Multiline Slot Machine,” by Hagiwara, which describes a means of showing matching symbols in a 3×3 matrix in horizontal, vertical and diagonal lines; and U.S. Pat. No. 6,251,013 B1, entitled “Slot Machine Game With Randomly Designated Special Symbols,” by Bennet, which generally describes a method of calculating a winning combination of symbols displayed in a row on a slot machine.

None of the above mentioned references, however, establish a methodology and/or system which calculates winner paylines based on a user's choice of one or more of row, column, diagonal, semi-diagonal and displaced-line payline calculations in a 5×5 matrix.

Gaming devices such as slot machines are quite common and popular. Within the gaming industry it is known that the format of slot machines needs to constantly change in order to sustain the fickle gambling population's attention. As is understood in the gaming arts, the slot machine industry is very competitive. If slot machine A of one manufacturer makes more money than machine B of another manufacturer, then machine B will be replaced by machine A, thereby benefiting the manufacturers of machine A. Casinos, therefore, constantly monitor the profitability of the machines on the floor of the casino. Like other products in commerce, slot machines come in and out of style. Well known changes in slot machine formats that have occurred over the years include the development of video slot machines and video poker.

In general, the key to slot machine profitability is getting more coins in the machine per play. The time required to play each of the conventional machines is roughly the same Therefore, the goal of slot machine manufacturers is to manufacture machines that increase the amount of time of play per day (time on device) or increase the number of coins deposited per payline and/or the number of paylines available to the user.

The traditional reel slot machine has three mechanical reels that rotate around a common horizontal axis. A reel strip is attached around the circumference of each slot reel and the reel strip contains a plurality of symbols thereon. As each reel comes to a stop, a symbol on the perimeter of the reel strip is displayed on a horizontal pay line on the face of the gaming machine. If the symbols that align on the payline match one of the preselected winning combinations, the player is a winner. Traditional slot machines have matrices of 3 rows and 3 columns, which represent a 9 reel machine with 8 potential paylines. More recently, 3×5 slot machines have been utilized in the industry. The 3×3 and 3×5 configurations, however, limit the user of the slot machines from selecting various payline configurations that are available on matrices of different sizes.

It is, therefore, apparent that the addition of more paylines to a slot machine creates more opportunity for the user to deposit coins into the machine per each use. Thus, the increased profitability of the machine would be a distinct and greatly desired advantage and, therefore, an advancement in the art. Applicants are, however, not aware of any gaming device that offers such a financially rewarding innovation. There is, therefore, a present need to provide an improved slot machine format that increases the profitability of the slot machine while the machine is in use.

Accordingly, it is an object of the present invention to provide the user of a slot machine with more opportunities to wager on paylines during each use of the slot machine.

It is a further object of the present invention to set forth an improved paradigm in which the user of a slot machine can select to wager on one or more of row, diagonal, column, semi-diagonal, and displaced-line paylines for each use of the slot machine.

It is a further object of the present invention to provide a slot machine that allows the user of the machine to wager on paylines in a matrix of rows and columns that is five rows by five columns.

It is a further object of the present invention to provide a slot machine that calculates winning paylines.

Finally, it is a further object of the present invention to provide a slot machine that informs the user of the slot machine that the user has successfully wagered on one or more winning paylines.

### SUMMARY OF THE INVENTION

The improved slot machine system and method in accordance with the present invention provides the user of the slot machine with increased opportunities to purchase wagers on multiple paylines. The increased number of wager opportunities is derived from the invention utilizing a 5×5 matrix of rows and columns and applying innovative payline patterns to the matrix, including row, diagonal, column, semi-diagonal and displaced-line payline patterns.

A more complete appreciation of the present invention and the scope thereof can be obtained from the accompanying drawings which are briefly summarized below in the following detailed description of the presently-preferred embodiments of the invention and appended claims.

### BRIEF DESCRIPTION OF THE DRAWINGS

FIG. 1 illustrates a slot machine gaming device that utilizes the principles taught by the present invention;

FIG. 2 is box diagram that illustrates the electronic processing of a slot machine gaming device that utilizes the principles taught by the present invention;

FIG. 3 is a diagram of a matrix composed of rows and columns that illustrates horizontal paylines for the present invention;

FIG. 4 is a diagram of a matrix composed of rows and columns that illustrates vertical paylines for the present invention;

FIG. 5 is a diagram of a matrix composed of rows and columns that illustrates diagonal paylines for the present invention; and

FIGS. 6, 7, 8, 9, and 10 are diagrams of a matrix composed of rows and columns that illustrate semi-diagonal paylines for the present invention;

FIGS. 11, 12, 13, 14, 15, 16, and 17 are diagrams of a matrix composed of rows and columns that illustrate displaced-line paylines for the present invention.

### DETAILED DESCRIPTION OF THE DRAWINGS

The following detailed description is presented to enable any person skilled in the art to make and use the invention. For purposes of explanation, specific nomenclature is set forth to provide a thorough understanding of the present invention. However, it will be apparent to one skilled in the art that these specific details are not required to practice the invention. Descriptions of specific applications are provided only as representative examples. Various modifications to the preferred embodiments will be readily apparent to one skilled in the art, and the general principles defined herein may be applied to other embodiments and applications without departing from the spirit and scope of the invention. The present invention is not intended to be limited to the embodiments shown, but is to be accorded the widest possible scope consistent with the principles and features disclosed herein.

As discussed, the present invention is directed to a significant improvement over the conventional techniques available in the current slot machine arts. In particular, the present invention utilizes a slot machine gaming device that has 25 reels, i.e., a five row by five column configuration. The larger matrix configuration and ability to wager on a variety of paylines are innovations that offer distinct advantages over the various prior conventional devices, such as those enumerated in the background section of this application hereinabove.

There are two recognized methods of increasing the profitability of a gaming device: 1) increase the time that an individual plays a particular machine, or 2) increase the amount of coins that a player wagers on a particular machine. Increasing the time that a player will play a particular gaming device is difficult and intangible to control. Instead, by providing a player with more opportunity to wager on more paylines during each use of a gaming device, the paradigm of the present invention increases the profitability of the gaming device.

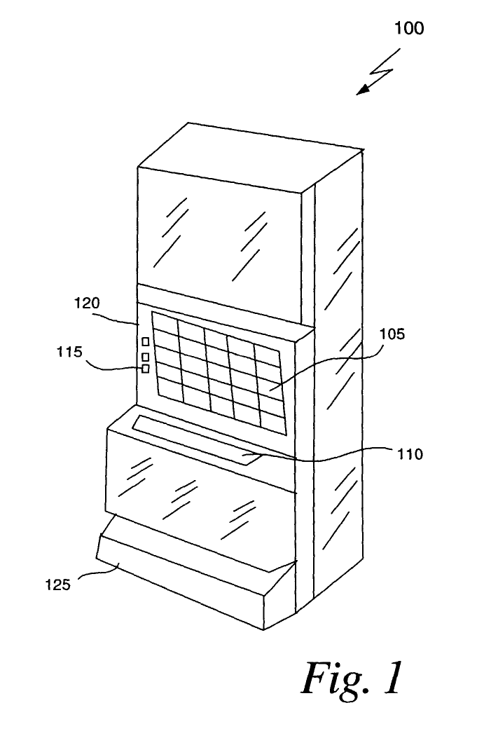

With reference now to FIG. 1 of the Drawings, there is illustrated therein a preferred embodiment of the present invention, a gaming device or slot machine generally designated by the reference numeral 100, that utilizes the principles of the present invention. As shown in FIG. 1, a matrix is displayed to the user via display 105 on the slot machine 100. As illustrated, the matrix is five rows by five columns large.

As is known in the gaming arts, a slot machine that utilizes a five-by-five matrix contains twenty five reels. A reel is an area where symbols, icons, or numbers are displayed on a slot machine. Further, in the preferred embodiment disclosed herein, there are disclosed 36 discrete paylines, described in more detail hereinbelow. Paylines are predetermined patterns of reels or symbol locations that users of a slot machine can wager upon.

The present invention allows the user of the slot machine to actively choose from a significantly larger number and type of wagers on paylines for each use of the machine than are offered by current gaming devices in the art. As shown in FIG. 1, the user of the slot machine may select which paylines to purchase wagers upon via a user-friendly control panel, generally designated by the reference numeral 110. The control panel 110 is preferably composed of buttons or switches that allow the user to designate paylines upon which to purchase a wager, as is well understood in the art. In an alternate embodiment, the user may select which wagers to purchase via a touch sensitive display of the matrix or by pressing selection keys surrounding the matrix display 120.

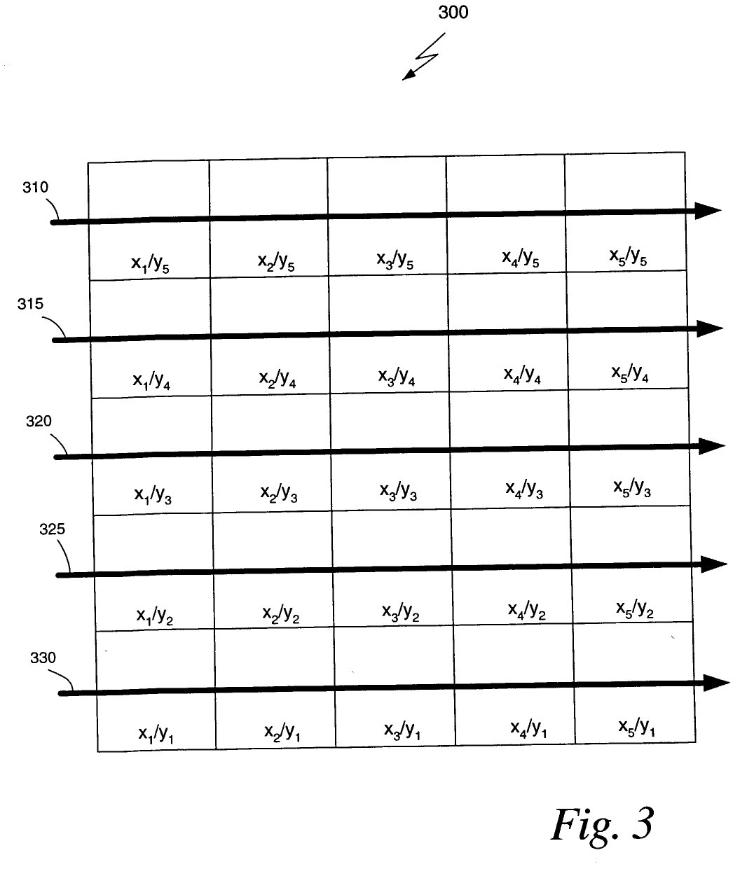

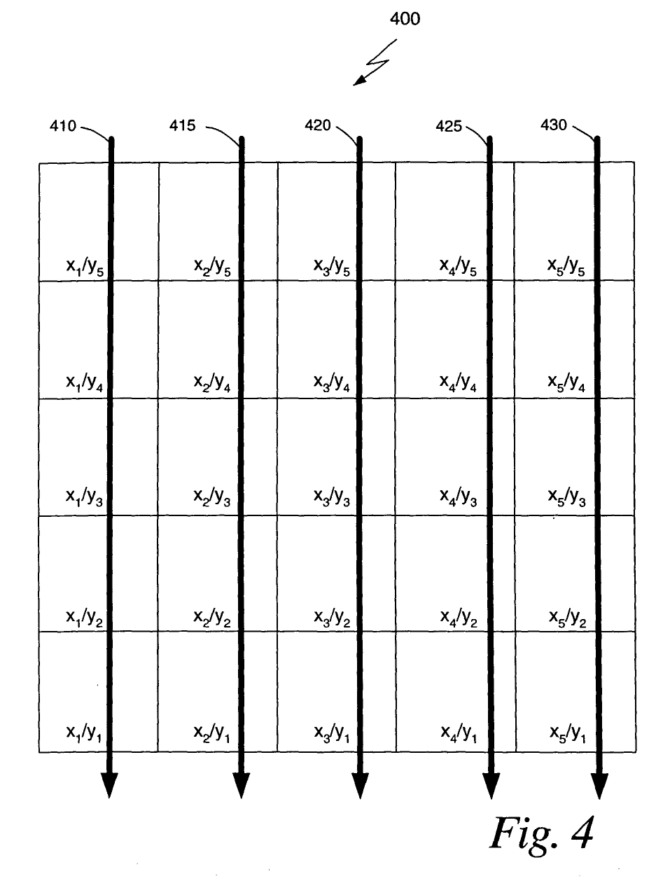

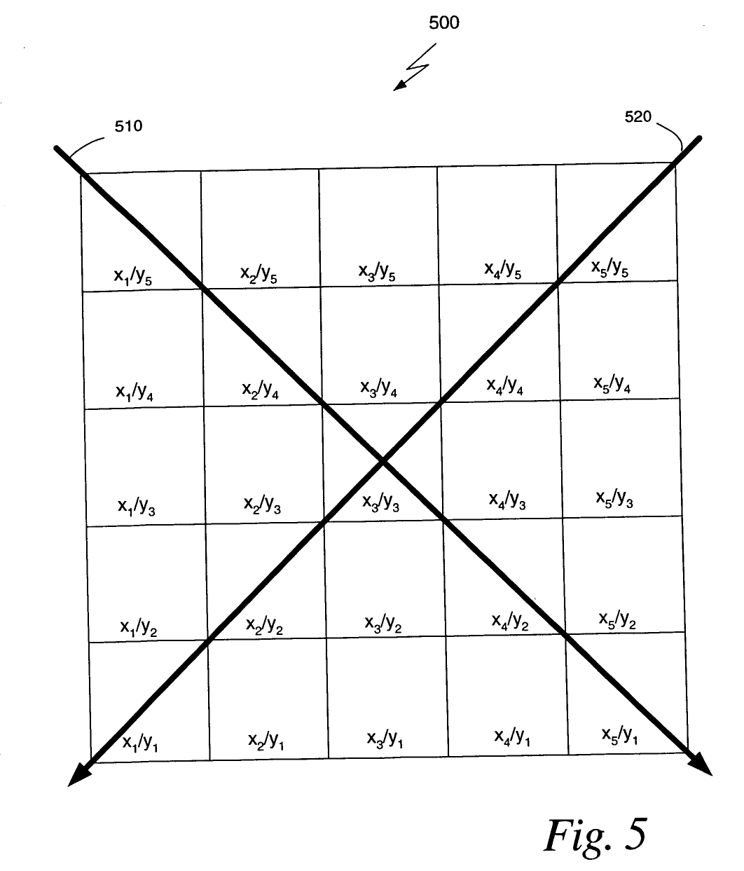

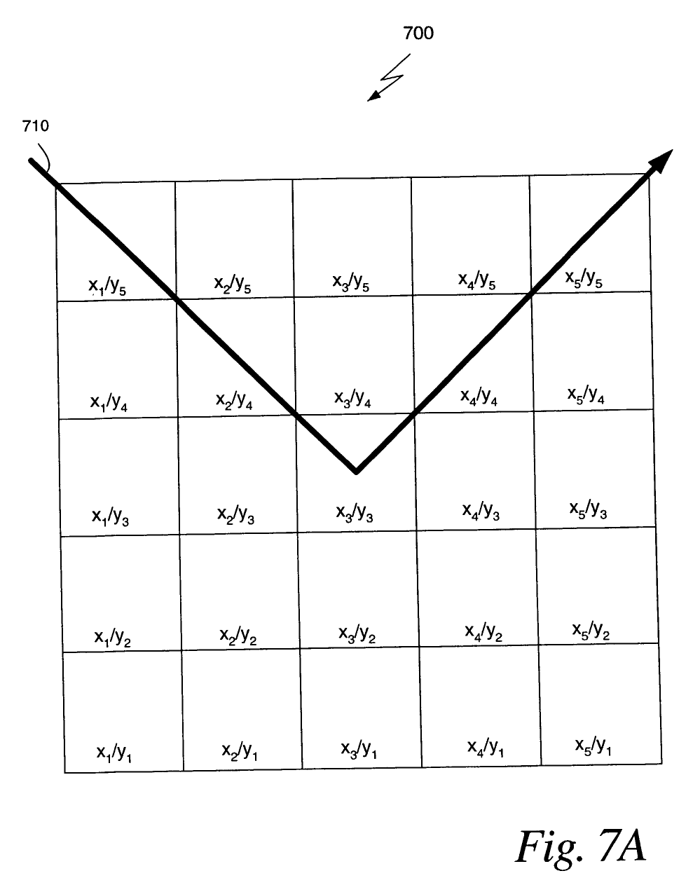

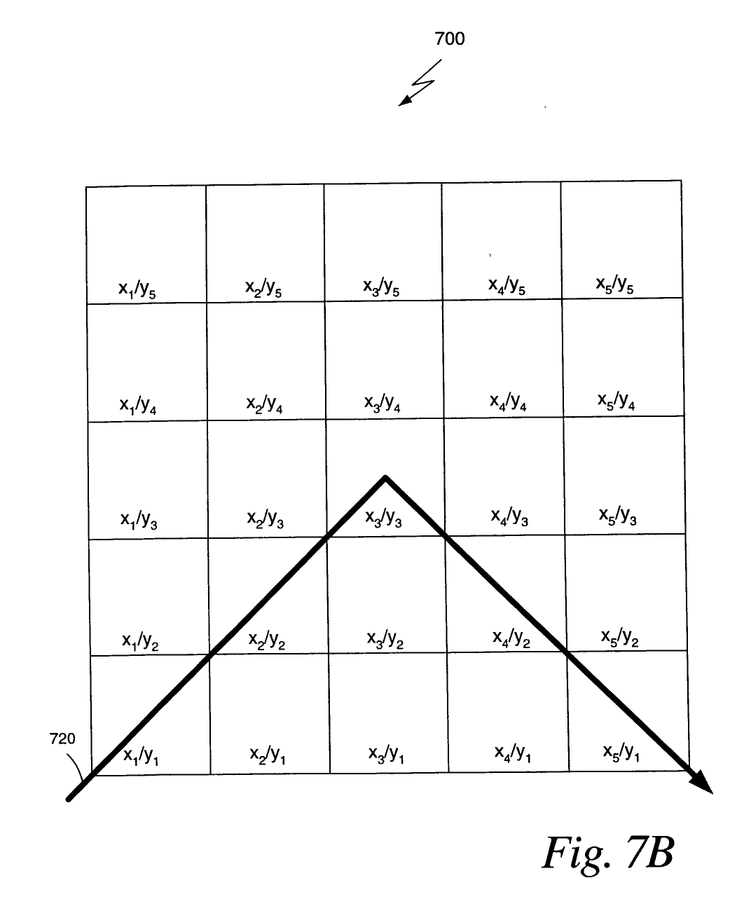

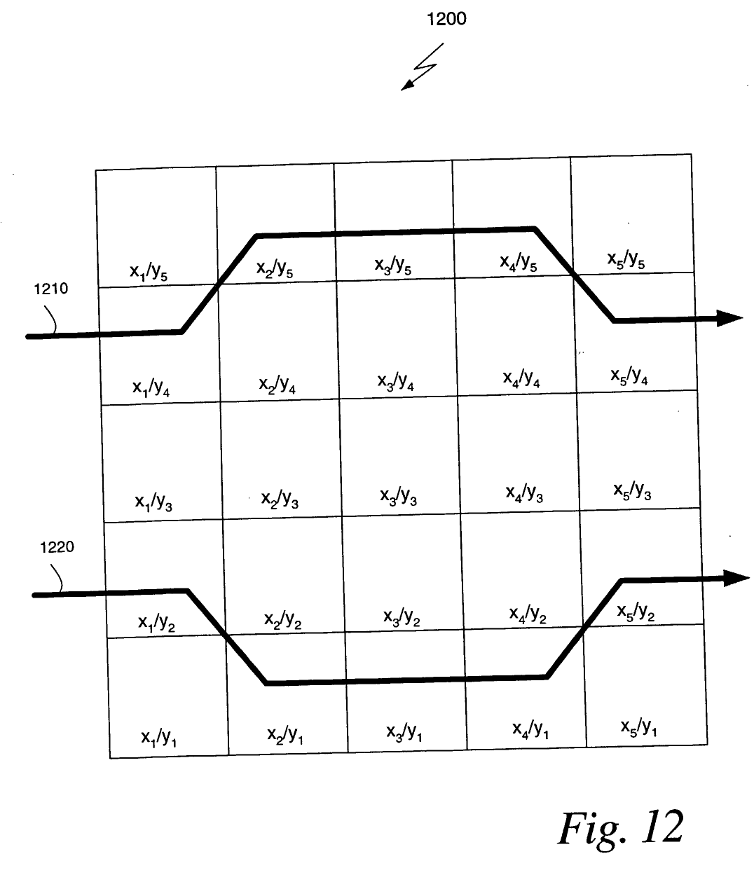

It should be appreciated that the present invention allows the user to place multiple wagers on separate paylines during each use of the slot machine, i.e., up to 36 separate wagers. The user may choose one or more of the following wagers: row, column, diagonal, semi-diagonal, and displaced-line wagers. Row wagers are wagers that fill a horizontal reel in the matrix, e.g., as further illustrated and described in connection with FIG. 3. Column wagers fill a vertical reel in the matrix, e.g., as further illustrated and described in connection with FIG. 4. Diagonal wagers are paylines that run on a diagonal from one corner of the matrix to another. It should be understood, of course, that there are but two distinct diagonal wagers, as further illustrated and described in connection with FIG. 5. Semi-diagonal wagers, however, are V-shaped paylines, as further illustrated and described in connection with FIGS. 7-11, and displaced-line wagers are paylines that that are composed of contiguous elements, that do not follow a straight line as further illustrated and described in connection with FIGS. 12-18. All of the above mentioned paylines are described and illustrated with greater detail in the teachings and detailed description of the present invention set forth hereinbeow.

In one embodiment, after the user has placed all wagers for the particular use of the slot machine 100 and the slot machine has randomly generated the output for the thirty-six paylines, the present invention then intelligently calculates whether or not the user of the slot machine purchased any wagers on the respective winning paylines. A winning payline may be determined in a number of ways and is dependent on the particular game that the slot machine offers. For example, the present invention may offer the user a game based upon traditional slot machine icons, or the invention may offer a game based upon poker concepts. If the user purchased a wager on one or more winning paylines, the invention then informs the user of such event and may dispense a prize or voucher to the user. As is well know in this art, the slot machine 100 may inform the user via the display 105 or some other alerting device, e.g., flashing lights, bells, etc. If the winner is entitled to collect any winnings from the slot machine, the winnings may be dispensed by the slot machine 100 via a dispenser portion 125.

In an alternative embodiment, the slot machine 100 does not randomly generate the output for the thirty-six paylines each time the slot machine is played, but instead selects a matrix pattern from a stack of predetermined patterns. The invention then compares the user selected paylines and the predetermined pattern and then intelligently calculates whether or not the user of the slot machine purchased any wagers on the winning paylines for that particular use of the machine. A winning payline may be determined as described above. This embodiment is consistent with Class II requirements for gaming devices as is known in the gaming arts.

The use of predetermined patterns is one of the important factors which distinguishes and allows the play of Class II activity. In the Class II embodiment, the invention itself does not actually control the outcome of the game as to whether or not a player is a winner and only assists in the play of the game. The outcome of a game is actually determined by the location of the predetermined patterns containing the winning indicia in a roll, stack or memory structure of the predetermined patterns. The invention enhances the play of the game. Thus in this embodiment, the apparatus of the invention merely dispenses but does not control whether or not a player will win in the gaming activity.

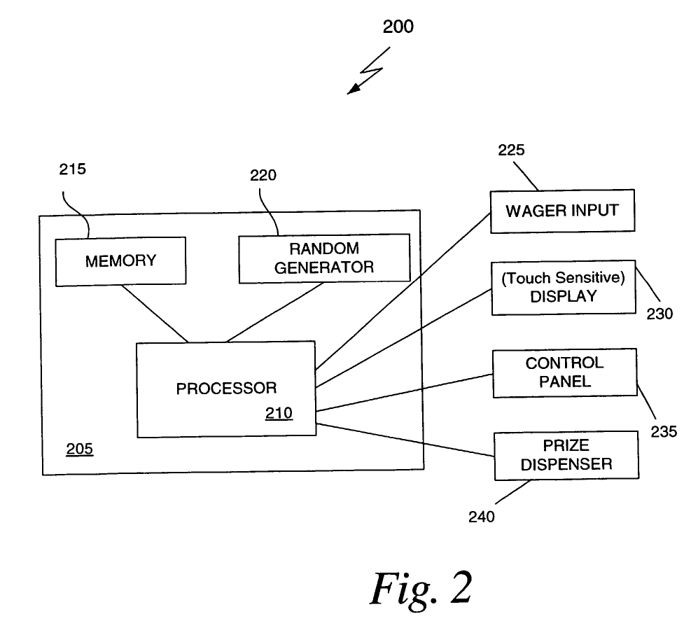

With reference now to FIG. 2 of the Drawings, there is illustrated therein a box diagram, generally designated by reference numeral 200, that generally illustrates the electronic processing of a slot machine gaming device that utilizes the principles taught by the present invention. A central controller 205 contains therein a processor 210, a memory unit 215 and a random generator 220. The processor 210 controls the various electronic processing elements. The memory 215 stores data, e.g., predetermined winning payline patterns used in the Class II embodiment, that may be used by the processor. The random generator 220 may be used to generate a random output of symbols for the gaming device. The wager input 225 recognizes when a user has inserted a wager into the machine to purchase a wager on a payline, e.g., inserted a coin or otherwise credited the machine. The display 230 is an output device that displays the matrix of rows and columns of symbols to the user, along with any other game-related information. The display 230 may be a video display or a touch sensitive screen that allows the user to choose paylines by touching the screen. Alternatively, the invention may be utilized with traditional slot machine displays of reels spinning around a horizontal axis. A control panel 235 is preferably a panel of switches or buttons that allows the user to choose paylines to wager upon, as is understood in the art. A prize dispenser 240 is controlled by the processor 210 and dispenses prizes to the user. Prizes may be in the form of currency, tokens, or other material items.

With reference now to FIG. 3 of the Drawings, there is illustrated therein a diagram of a matrix composed of rows and columns, generally designated by reference numeral 300, that illustrates the respective horizontal paylines for the present invention. As illustrated, matrix 300 is composed of five columns, represented by x₁, x₂, x₃, x₄, and x₅ and five rows, represented the y₁, y₂, y₃, y₄, and y₅. The five available horizontal paylines that a user of the slot machine 100 may select are generally designated in FIG. 3 by the reference numerals 310-330.

With reference now to FIG. 4 of the Drawings, there is illustrated therein a diagram of a matrix composed of rows and columns, generally designated by the reference numeral 400, that illustrates the respective vertical paylines for the present invention. The matrix 400 is composed of five rows and five columns, x₁/y₁ to x₅/y₅, as illustrated and described in connection with FIG. 3 hereinabove. The five available vertical paylines that a user of the slot machine may select are generally designated in FIG. 4 by the reference numerals 410-430.

With reference now to FIG. 5 of the Drawings, there is illustrated therein a diagram of a matrix composed of rows and columns, generally designated by the reference numeral 500, that illustrates the two diagonal paylines for the present invention. The matrix 500 is composed of five rows and five columns, as illustrated and described in connection with FIG. 3. The particular diagonal paylines that a user of the slot may select are generally designated in FIG. 5 by the reference numerals 510 and 520.

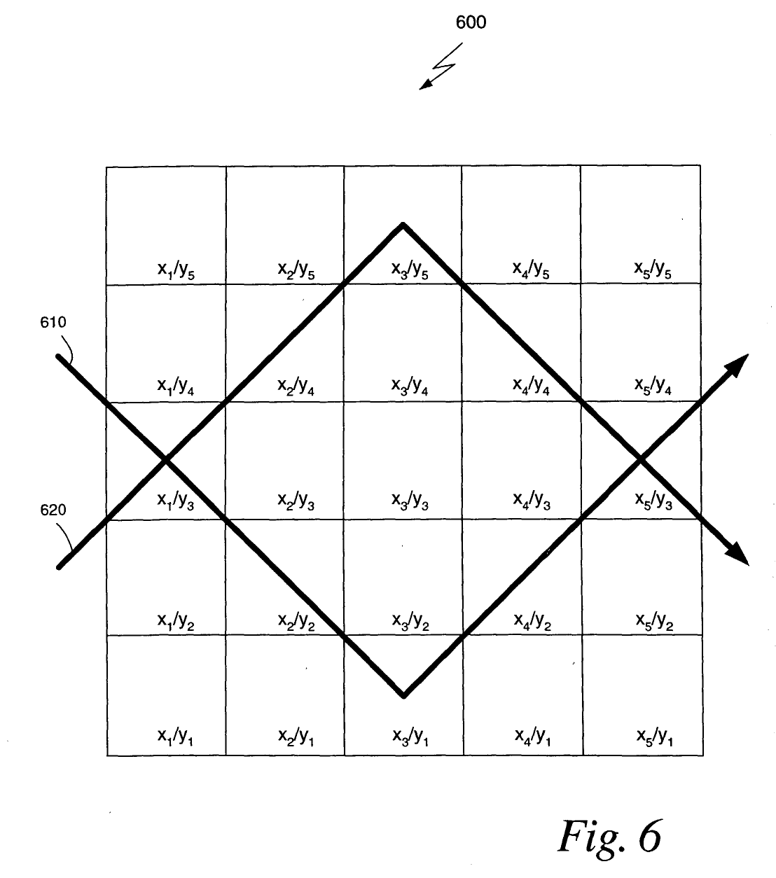

With reference now to FIG. 6 of the Drawings, there is illustrated therein a diagram of a matrix composed of rows and columns, generally designated by the reference numeral 600, that illustrates two of the eight possible semi-diagonal paylines for the present invention. The matrix 600 is composed of five rows and five columns, as described in FIG. 3. The two semi-diagonal paylines that are depicted in FIG. 6 are designated by the reference numerals 610 and 620, respectively. Semi-diagonal payline 610 of the matrix 600 populates elements x₁/y₃, x₂/y₂, x₃/y₁, x₄/y₂ and x₅/y₃. Semi-diagonal payline 620 of the matrix, in turn, populates elements x₁/y₃, x₂/y₄, x₃/y₅, x₄/y₄ and x₅/y₃.

With reference now to FIG. 7 of the Drawings, there is illustrated therein a diagram of a matrix composed of rows and columns, generally designated by the reference numeral 700, that illustrates an additional two of the eight possible semi-diagonal paylines for the present invention. The matrix 700 is composed of five rows and five columns, as described in FIG. 3. The two semi-diagonal paylines that are depicted in FIG. 7 are designated by the reference numerals 710 and 720, respectively. Semi-diagonal payline 710 of the matrix 700 populates elements x₁/y₅, x₂/y₄, x₃/y₃, x₄/y₄ and x₅/y₅. Semi-diagonal payline 720 of the matrix, in turn, populates elements x₁/y₁, x₂/y₂, x₃/y₃, x₄/y₂ and x₅/y₁.

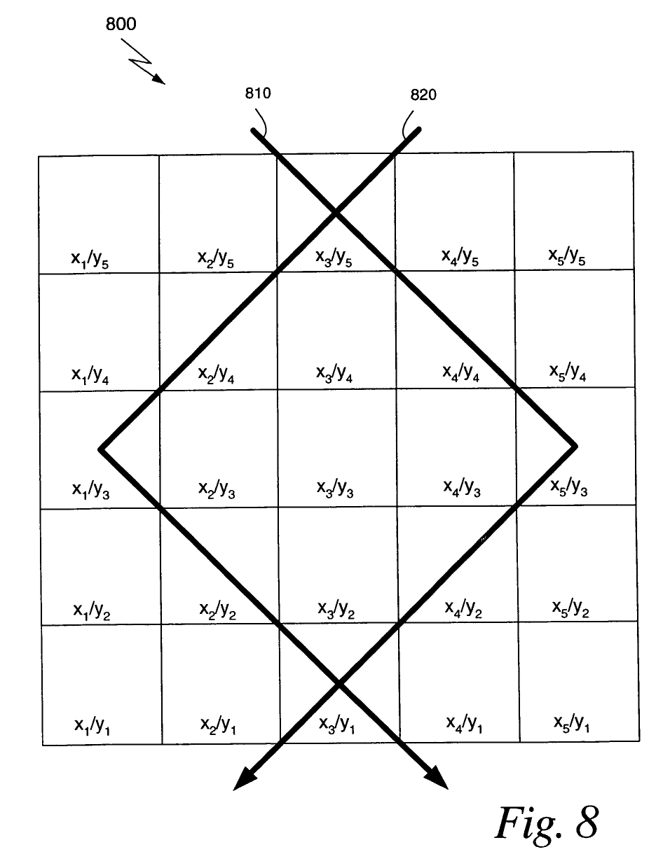

With reference now to FIG. 8 of the Drawings, there is illustrated therein a diagram of a matrix composed of rows and columns, generally designated by the reference numeral 800 that illustrates two other of the eight possible semi-diagonal paylines for the present invention. The matrix 800 is composed of five rows and five columns, as described in FIG. 3. The two semi-diagonal paylines that are depicted in FIG. 8 are designated by the reference numerals 810 and 820, respectively. Semi-diagonal payline 810 of the matrix 800 populates elements x₃/y₅, x₄/y₄, x₅/y₃, x₄/y₂ and x₃/y₁. Semi-diagonal payline 820 of the matrix, in turn, populates elements x₃/y₅, x₂/y₄, x₁/y₃, x₂/y₂ and x₃/y₁.

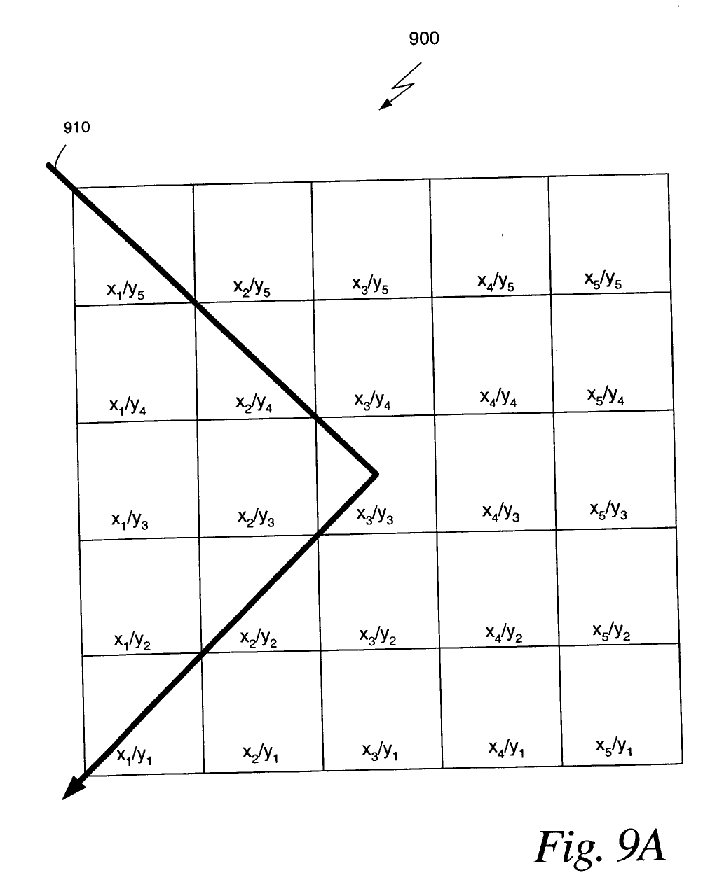

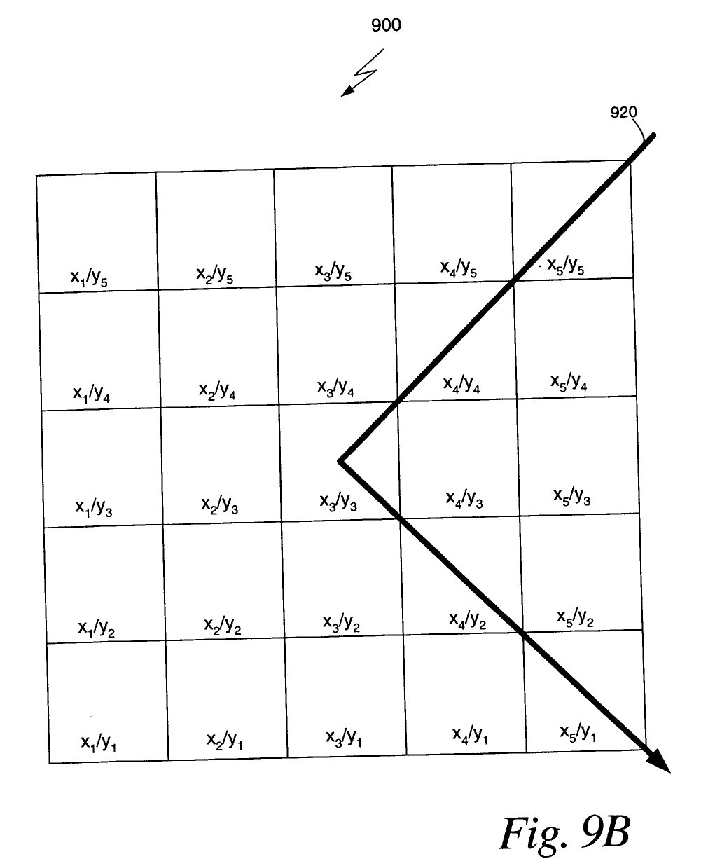

With reference now to FIG. 9 of the Drawings, there is illustrated therein a diagram of a matrix composed of rows and columns, generally designated by the reference numeral 900, that illustrates the remaining two of the eight possible semi-diagonal paylines for the present invention. The matrix 900 is composed of five rows and five columns, as described in FIG. 3. The two semi-diagonal paylines that are depicted in FIG. 9 are designated by the reference numerals 910 and 920, respectively. Semi-diagonal payline 910 of the matrix 900 populates elements x₁/y₅, x₂/y₄, x₃/y₃, x₂/y₂ and x₁/y₁. Semi-diagonal payline 920 of the matrix, in turn, populates elements x₅/y₅, x₄/y₄, x₃/y₃, x₄/y₂ and x₅/y₁.

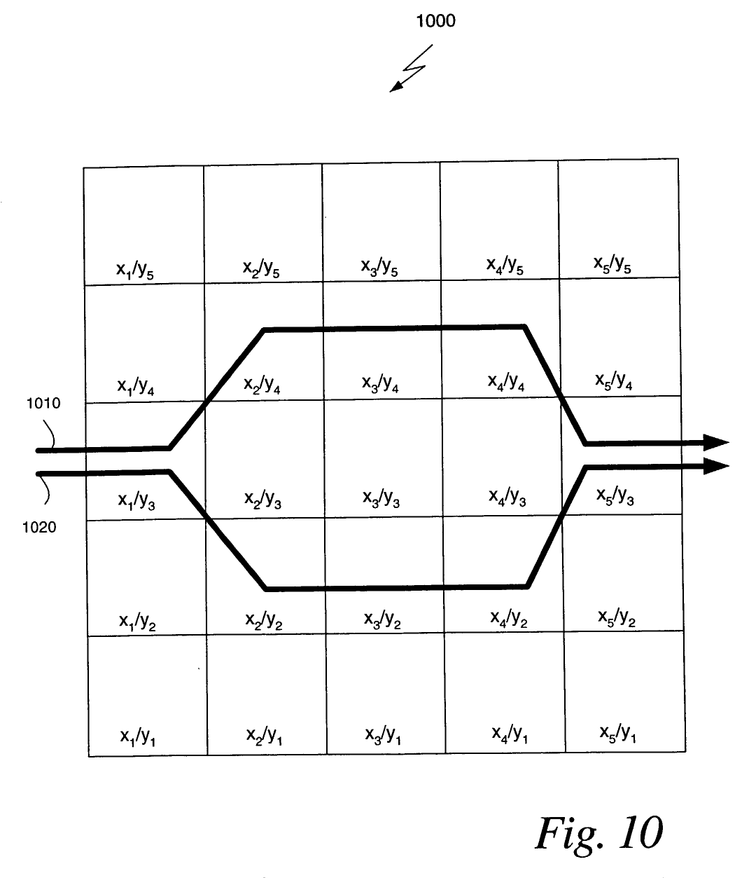

With reference now to FIG. 10 of the Drawings, there is illustrated therein a diagram of a matrix composed of rows and columns, generally designated by the reference numeral 1000, that illustrates two of the sixteen possible displaced-line paylines for the present invention. The matrix 1000 is composed of five rows and five columns, as described in FIG. 3. The two displaced-line paylines that are depicted in FIG. 10 are designated by the reference numerals 1010 and 1020, respectively. Displaced-line payline 1010 of the matrix 1000 populates elements x₁/y₃, x₂/y₄, x₃/y₄, x₄/y₄ and x₅/y₃. Displaced-line payline 1020 of the matrix, in turn, populates elements x₁/y₃, x₂/y₂, x₃/y₂, x₄/y₂ and x₅/y₃.

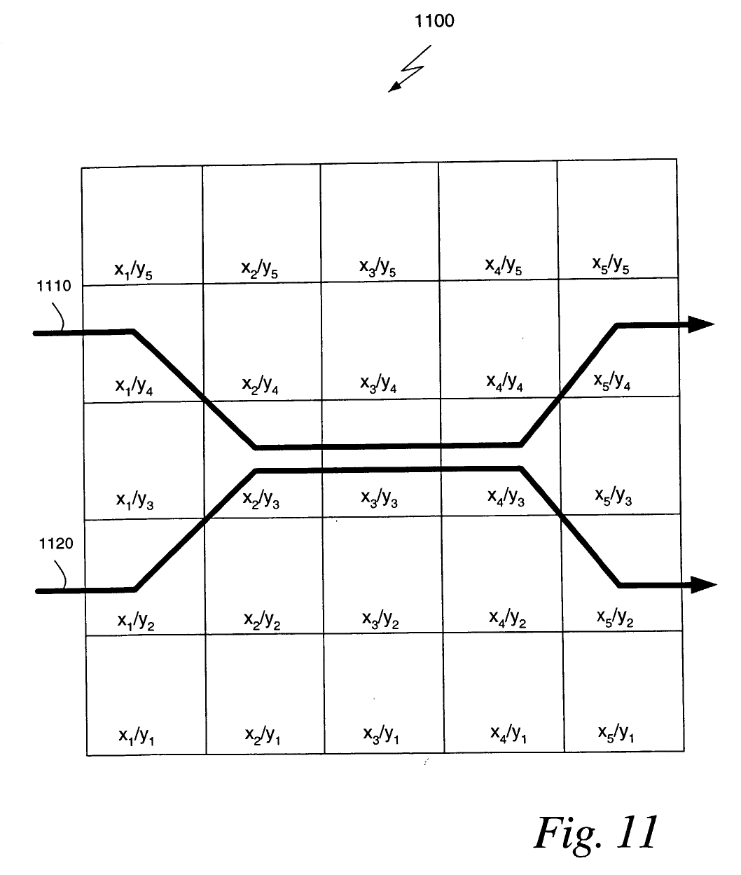

With reference now to FIG. 11 of the Drawings, there is illustrated therein a diagram of a matrix composed of rows and columns, generally designated by the reference numeral 1100, that illustrates another two of the sixteen possible displaced-line paylines for the present invention. The matrix 1100 is composed of five rows and five columns, as described in FIG. 3. The two displaced-line paylines that are depicted in FIG. 11 are designated by the reference numerals 1110 and 1120, respectively. Displaced-line payline 1110 of the matrix 1100 populates elements x₁/y₄, x₂/y₃, x₃/y₃, x₄/y₃ and x₅/y₄. Displaced-line payline 1120 of the matrix, in turn, populates elements x₁/y₂, x₂/y₃, x₃/y₃, x₄/y₃ and x₅/y₂.

With reference now to FIG. 12 of the Drawings, there is illustrated therein a diagram of a matrix composed of rows and columns, generally designated by the reference numeral 1200, that illustrates a further two of the sixteen possible displaced-line paylines for the present invention. The matrix 1200 is composed of five rows and five columns, as described in FIG. 3. The two displaced-line paylines that are depicted in FIG. 12 are designated by the reference numerals 1210 and 1220, respectively. Displaced-line payline 1210 of the matrix 1200 populates elements x₁/y₄, x₂/y₅, x₃/y₅, x₄/y₅ and x₅/y₄. Displaced-line payline 1220 of the matrix, in turn, populates elements x₁/y₂, x₂/y₁, x₃/y₁, x₄/y₁ and x₅/y₂.

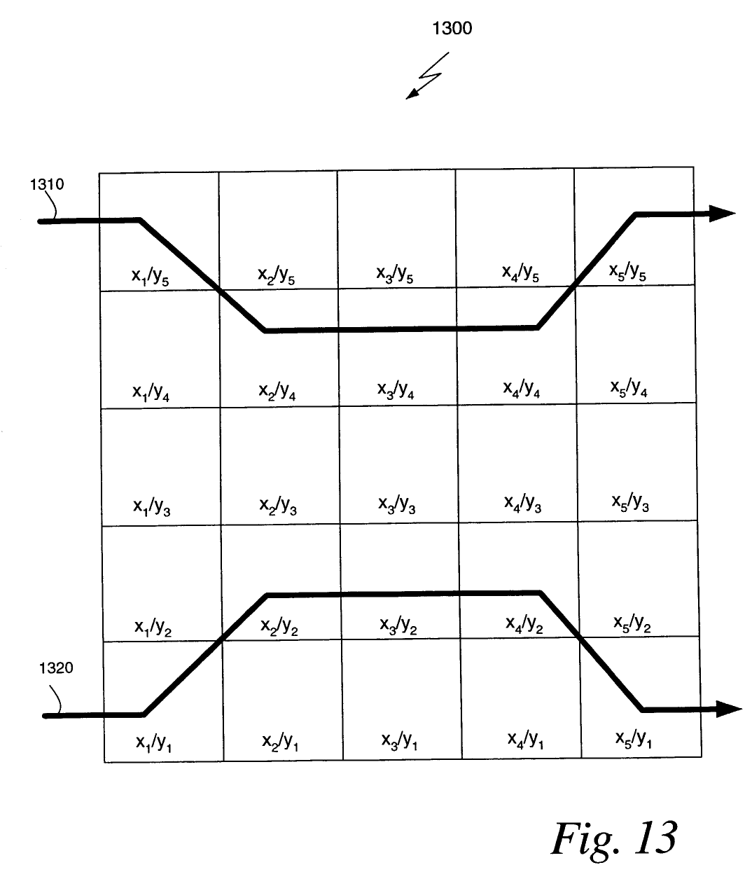

With reference now to FIG. 13 of the Drawings, there is illustrated therein a diagram of a matrix composed of rows and columns, generally designated by the reference numeral 1300, that illustrates another two of the sixteen possible displaced-line paylines for the present invention. The matrix 1300 is composed of five rows and five columns, as described in FIG. 3. The two displaced-line paylines that are depicted in FIG. 13 are designated by the reference numerals 1310 and 1320, respectively. Displaced-line payline 1310 of the matrix 1300 populates elements x₁/y₅, x₂/y₄, x₃/y₄, x₄/y₄ and x₅/y₅. Displaced-line payline 1320 of the matrix, in turn, populates elements x₁/y₁, x₂/y₂, x₃/y₂, x₄/y₂ and x₅/y₁.

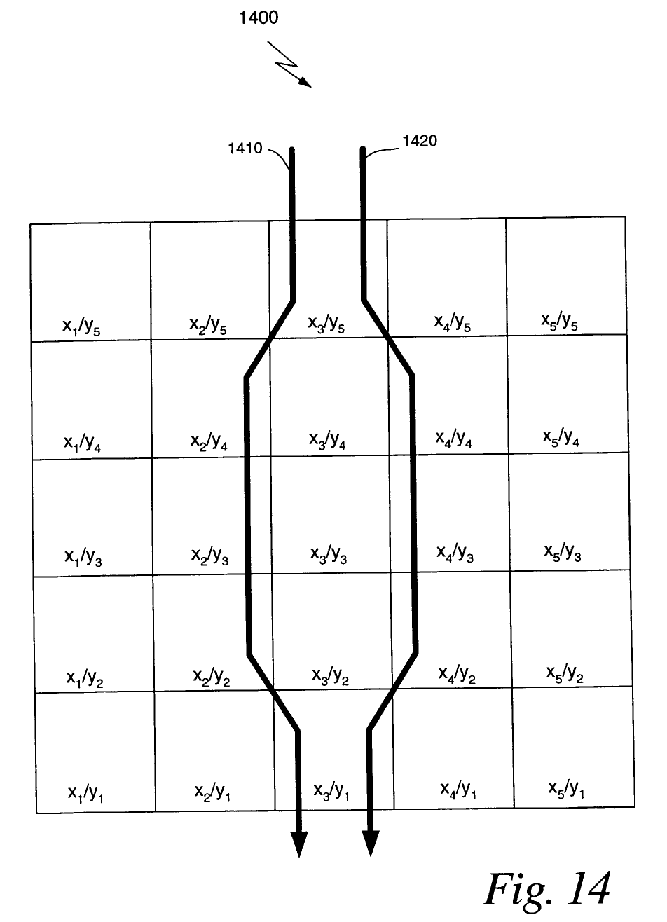

With reference now to FIG. 14 of the Drawings, there is illustrated therein a diagram of a matrix composed of rows and columns, generally designated by the reference numeral 1400, that illustrates an additional two of the sixteen possible displaced-line paylines for the present invention. The matrix 1400 is composed of five rows and five columns, as described in FIG. 3. The two displaced-line paylines that are depicted in FIG. 14 are designated by the reference numerals 1410 and 1420, respectively. Displaced-line payline 1410 of the matrix 1400 populates elements x₃/y₅, x₂/y₄, x₂/y₃, x₂/y₂ and x₃/y₁. Displaced-line payline 1420 of the matrix, in turn, populates elements x₃/y₅, x₄/y₄, x₄/y₃, x₄/y₂ and x₃/y₁.

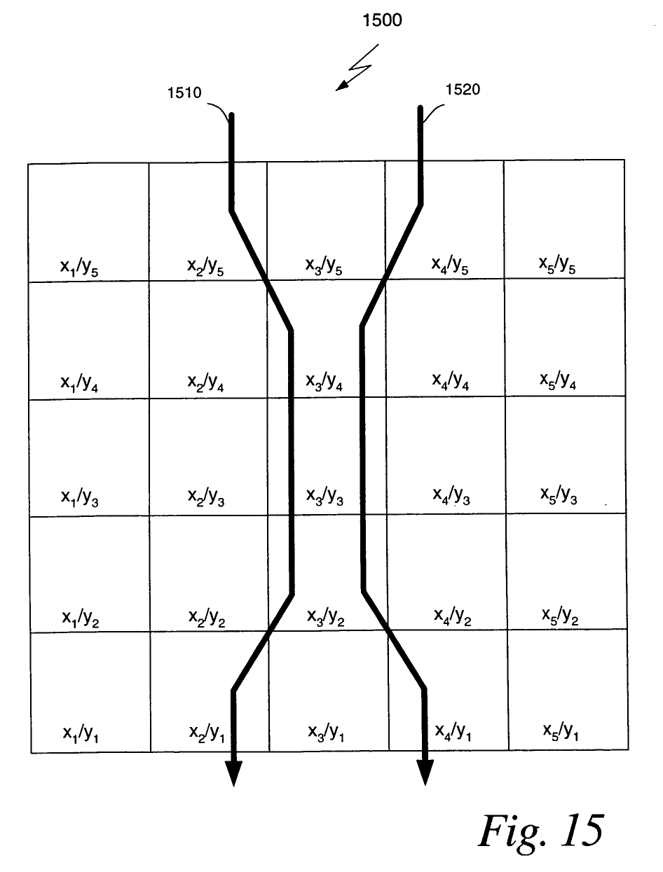

With reference now to FIG. 15 of the Drawings, there is illustrated therein a diagram of a matrix composed of rows and columns, generally designated by the reference numeral 1500, that illustrates another two of the sixteen possible displaced-line paylines for the present invention. The matrix 1500 is composed of five rows and five columns, as described in FIG. 3. The two displaced-line paylines that are depicted in the figure are designated by the reference numerals 1510 and 1520, respectively. Displaced-line payline 1510 of the matrix 1500 populates elements x₂/y₅, x₃/y₄, x₃/y₃, x₃/y₂ and x₂/y₁. Displaced-line payline 1520 of the matrix 1500, in turn, populates elements x₄/y₅, x₃/y₄, x₃/y₃, x₃/y₂ and x₄/y₁.

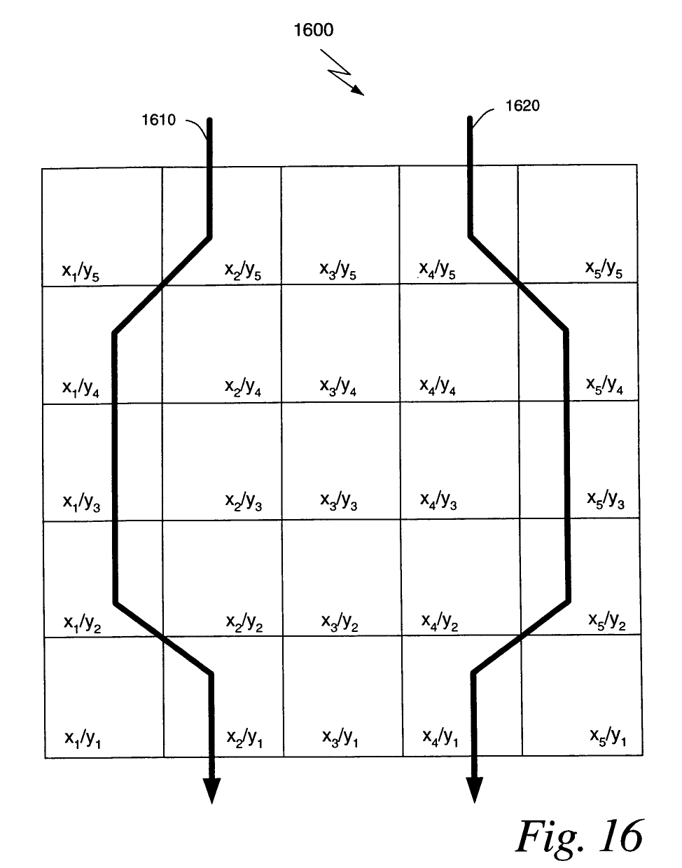

With reference now to FIG. 16 of the Drawings, there is illustrated therein a diagram of a matrix composed of rows and columns, generally designated by the reference numeral 1600, that illustrates still another two of the sixteen possible displaced-line paylines for the present invention. The matrix 1600 is composed of five rows and five columns, as described in FIG. 3. The two displaced-line paylines that are depicted in the figure are designated by the reference numerals 1610 and 1620, respectively. Displaced-line payline 1610 of the matrix 1600 populates elements x₂/y₅, x₁/y₄, x₁/y₃, x₁/y₂ and x₂/y₁. Displaced-line payline 1620 of the matrix, in turn, populates elements x₄/y₅, x₅/y₄, x₅/y₃, x₅/y₂ and x₄/y₁.

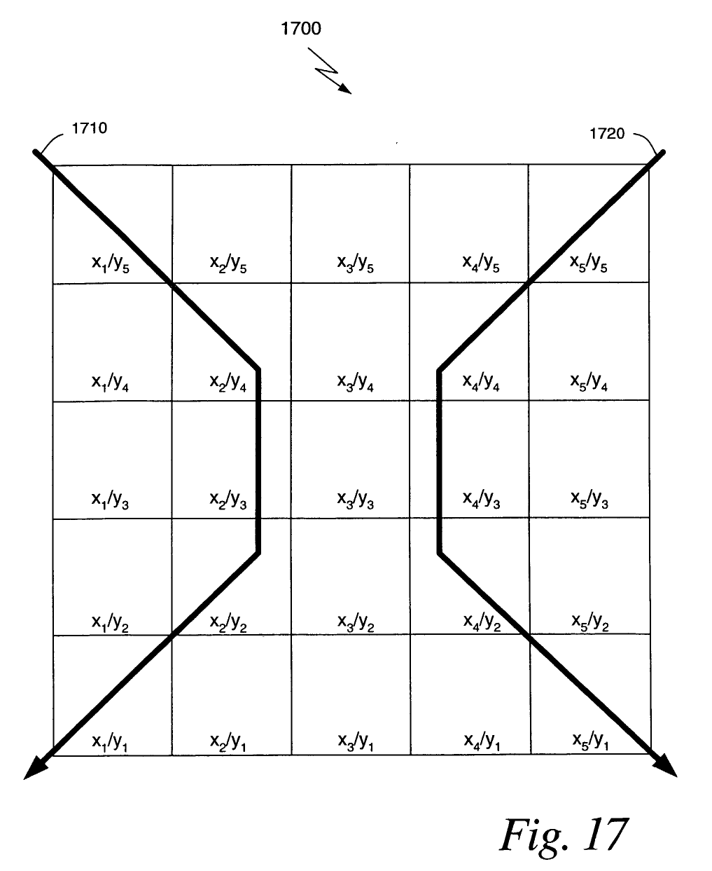

With reference now to FIG. 17 of the Drawings, there is illustrated therein a diagram of a matrix composed of rows and columns, generally designated by the reference numeral 1700 that illustrates the final two of the sixteen possible displaced-line paylines for the present invention. The matrix 1700 is composed of five rows and five columns, as described in FIG. 3. The two displaced-line paylines that are depicted in the figure are designated by the reference numerals 1710 and 1720, respectively. Displaced-line payline 1710 of the matrix 1700 populates elements x₁/y₅, x₂/y₄, x₂/y₃, x₂/y₂ and x₁/y₁. Displaced-line payline 1720 of the matrix 1700, in turn, populates elements x₅/y₅, x₄/y₄, x₄/y₃, x₄/y₂ and x₅/y₁.

The foregoing description of the present invention provides illustration and description, but is not intended to be exhaustive or to limit the invention to the precise one disclosed. Modifications and variations are possible consistent with the above teachings or may be acquired from practice of the invention. Thus, it is noted that. the scope of the invention is defined by the claims and their equivalents.

What is claimed:

1. In a gaming device, a method for selecting one or more of a variety of paylines, said paylines derived from a square matrix composed of five rows and five columns, said method comprising the steps of:
selecting, by the user of said gaming device, one or more said paylines;
generating, by said gaming device, a random output of symbols to populate the elements of said matrix;
displaying said random output on an output device;
calculating, by said gaming device, winning paylines;
alerting, by said gaming device, said user of winning paylines; and
dispensing, by said gaming device, prizes for winning paylines.

2. The method according to claim 1, wherein said paylines are selected from the group consisting of row, column, diagonal, semi-diagonal, and displaced line paylines.

3. The method according to claim 1, wherein said step of selecting one or more paylines, further comprises the step of selecting said paylines via a control panel on said gaming device.

4. The method according to claim 1, wherein said step of selecting one or more paylines, further comprises the step of selecting said paylines via a touch sensitive screen.

5. The method according to claim 1, wherein said step of selecting one or more paylines, further comprises the step of selecting said paylines via selection devices surrounding said matrix.

6. The method according to claim 1, wherein said step of generating a random output of symbols, further comprises the step of generating a random output of symbols via an internal computer in said gaming device.

7. The method according to claim 1, wherein said step of generating a random output of symbols, further comprises the step of generating a random output of symbols via spinning reels in said gaming device.

8. The method according to claim 1, wherein said output device is a video display.

9. The method according to claim 1, wherein said step of calculating winning paylines further comprises the step of calculating winning paylines via an internal computer in said gaming device.

10. In a gaming device, a method for selecting one or more of a variety of paylines, said paylines derived from a square matrix composed of five rows and five columns, said method comprising the steps of:
selecting, by the user of said gaming device, one or more said paylines;
selecting, by said gaming device, a predetermined output of symbols to populate the elements of said matrix;
displaying said predetermined output on an output device;
calculating, by said gaming device, winning paylines;
alerting, by said gaming device, said user of winning paylines; and
dispensing, by said gaming device, prizes for winning paylines.

11. The method according to claim 10, wherein said paylines are selected from the group consisting of row, column, diagonal, semi-diagonal, and displaced line paylines.

12. The method according to claim 10, wherein said step of selecting one or more paylines, further comprises the step of selecting said paylines via a control panel on said gaming device.

13. The method according to claim 10, wherein said step of selecting one or more paylines, further comprises the step of selecting said paylines via a touch sensitive screen.

14. The method according to claim 10, wherein said step of selecting one or more paylines, further comprises the step of selecting said paylines via selection devices surrounding said matrix.

15. The method according to claim 10, wherein said step of selecting a predetermined output of symbols, further comprises the step of selecting a predetermined output of symbols from memory in said gaming device.

16. The method according to claim 10, wherein said output device is a video display.

17. The method according to claim 10 wherein said step of calculating winning paylines further comprises the step of comparing said predetermined output to said user selected paylines.

18. In a gaming device, a system for selecting paylines in a matrix of five rows and five columns, said paylines including at least one of row, column, diagonal, semi-diagonal, and displaced line paylines, said system comprising:
a selection device for the user of said gaming device to select one or more paylines;
a display for said gaming device to output randomly generated paylines;
an output device to alert said user of selected winning paylines and award prizes; and
processor means for receiving said user selections, generating random output to populate said paylines, calculating winning paylines, alerting said user of selected winning paylines, and dispensing prizes.

19. The gaming device system according to claim 18 wherein said selection device is a touch sensitive screen.

20. The gaming device system according to claim 18 wherein said selection device is a control panel of buttons and switches.

21. The gaming device system according to claim 18 wherein said display is a video output.

22. The gaming device system according to claim 18 wherein said display is comprised of spinning reels of symbols that compose said paylines in said matrix.

23. The gaming device system according to claim 18 wherein said processor means is an internal computer.

24. In a gaming device, a system for selecting paylines in a matrix of five rows and five columns, said paylines including at least one of row, column, diagonal, semi-diagonal, and displaced line paylines, said system comprising:
a selection device for the user of said gaming device to select one or more paylines;
a display for said gaming device to display predetermined matrix output;
an output device to alert said user of selected winning paylines and award prizes; and
processor means for receiving said user selections, selecting said predetermined matrix output to populate said paylines, calculating winning paylines, alerting said user of selected winning paylines, and dispensing prizes.

25. The gaming device system according to claim 24 wherein said selection device is a touch sensitive screen.

26. The gaming device system according to claim 24 wherein said selection device is a control panel of buttons and switches.

27. The gaming device system according to claim 24 wherein said display is a video output.

28. The gaming device system according to claim 24 wherein said display is comprised of spinning reels of symbols that compose said paylines in said matrix.

29. The gaming device system according to claim 24 wherein said processor means is an internal computer.

30. A gaming device comprising:
a matrix, said matrix composed of five rows and five columns, displaying symbols that populate the elements of said matrix;
selecting means for the user of said gaming device to select one or more paylines, said paylines including at least one of row, column, diagonal, semi-diagonal, and displaced line paylines;
a first processing means to randomly populate the elements of said matrix with symbols;
a display means to display said user selections and said randomly generated symbols;
a second processing means to calculate winning paylines;
an alerting means to notify said user of any winning paylines; and
a dispensing means to award prizes.

31. A gaming device comprising:
a matrix, said matrix composed of five rows and five columns, displaying symbols that populate the elements of said matrix;
selecting means for the user of said gaming device to select one or more paylines, said paylines including at least one of row, column, diagonal, semi-diagonal, and displaced line paylines;
a first processing means to populate the elements of said matrix with predetermined patterns of symbols;
a display means to display said user selections and said predetermined patterns of symbols;
a second processing means to calculate winning paylines;
an alerting means to notify said user of any winning paylines; and
a dispensing means to award prizes.
